(19) United States
(12) Patent Application Publication
(10) Pub. No.: US 2017/0352122 A1
(43) Pub. Date: Dec. 7, 2017

(54) POSTAL SYSTEM OF RECOGNITION OF PHYSICAL CORRESPONDENCE

(71) Applicant: ARMARK LLC, Little Neck, NY (US)

(72) Inventor: Armen Markarian, Bayside, NY (US)

(73) Assignee: ARMARK LLC, LITTLE NECK, NY (US)

(21) Appl. No.: 15/683,774

(22) Filed: Aug. 22, 2017

Related U.S. Application Data
(63) Continuation of application No. PCT/IB2016/000180, filed on Feb. 23, 2016.

(51) Int. Cl. G06Q 50/26; G06K 9/32; B07C 5/02; B07C 3/14; B07C 5/28; B07C 5/08; G06K 9/62; B07C 5/34

(52) U.S. Cl. CPC G06Q 50/26; G06K 9/6201; G06K 9/325; B07C 5/3412; B07C 3/14; B07C 5/28; B07C 5/08; B07C 5/02; B07C 2301/0058

(57) ABSTRACT

An apparatus for physical correspondence recognition and processing in a postal system is described, comprising a housing comprising an opening for receiving physical correspondence, the physical correspondence including a readable element including textual information, and a secure enclosure for storing the physical correspondence, a visual processing and digitizing component, for processing the physical correspondence and the at least one readable element, dimension and weighing component for determining dimensions and weight of the physical correspondence, and a communication component coupled to the housing, for transmitting and receiving recognition and processing information related to the physical correspondence and readable element.

### BACKGROUND

Although electronic mail use continues to rise, people continue to rely on postal service systems to send and receive paper mail and correspondence for particular types of correspondence and situations. The postal service systems today continue to provide reliable service by receiving, sorting, routing and transporting mail.

### SUMMARY

An aspect of some embodiments of the invention provides an apparatus for physical correspondence recognition and processing in a postal system, the apparatus comprising a housing comprising an opening configured for receiving physical correspondence, the physical correspondence including at least one readable element including textual information, and a secure enclosure for storing the physical correspondence, a visual processing and digitizing component coupled to the housing or the opening, configured for processing the physical correspondence and the at least one readable element including textual information, a dimension and weighing component coupled to the housing, configured for determining dimensions and weight of the physical correspondence, and a communication component coupled to the housing, configured for transmitting and receiving recognition and processing information related to the physical correspondence and the readable element.

### BRIEF DESCRIPTION OF THE DRAWINGS

FIG. 1 illustrates a block diagram of a postal device and system according to an embodiment of the invention;

FIG. 2 illustrates a block diagram of a distributed computerized postal system that can implement one or more aspects of a Postal System, Apparatus or Method of Recognition of Physical Correspondence according to an embodiment of the invention of Recognition of Physical Correspondence according to an embodiment of the invention;

FIG. 3 illustrates a block diagram of a distributed computerized postal system that can implement one or more aspects of a Postal System, Apparatus or Method of Recognition of Physical Correspondence according to an embodiment of the invention;

FIG. 4 illustrates a block diagram of a distributed computerized postal system that can implement one or more aspects of a Postal System, Apparatus or Method of Recognition of Physical Correspondence according to an embodiment of the invention;

FIG. 5 illustrates a block diagram of a distributed computerized postal system that can implement one or more aspects of a Postal System, Apparatus or Method of Recognition of Physical Correspondence according to an embodiment of the invention;

FIG. 6 illustrates a diagram of a postal device and system according to one or more aspects of a Postal System, Apparatus or Method of Recognition of Physical Correspondence according to an embodiment of the invention;

FIG. 7 illustrates a diagram of a postal device and system according to one or more aspects of a Postal System, Apparatus or Method of Recognition of Physical Correspondence according to an embodiment of the invention;

FIG. 8 illustrates a diagram of a postal device and system according to one or more aspects of a Postal System, Apparatus or Method of Recognition of Physical Correspondence according to an embodiment of the invention;

FIG. 9 illustrates a diagram of a postal device and system according to one or more aspects of a Postal System, Apparatus or Method of Recognition of Physical Correspondence according to an embodiment of the invention;

FIG. 10 illustrates a block diagram of a postal device and system that can implement one or more aspects of a Postal System, Apparatus or Method of Recognition of Physical Correspondence according to an embodiment of the invention;

FIG. 11 illustrates a block diagram of a postal device and system that can implement one or more aspects of a Postal System, Apparatus or Method of Recognition of Physical Correspondence according to an embodiment of the invention;

FIG. 12 illustrates a block diagram of a postal device and system that can implement one or more aspects of a Postal System, Apparatus or Method of Recognition of Physical Correspondence according to an embodiment of the invention;

FIG. 13 illustrates a diagram of a postal device and system according to one or more aspects of a Postal System, Apparatus or Method of Recognition of Physical Correspondence according to an embodiment of the invention;

FIG. 14 illustrates a block diagram of a postal device and system according to an embodiment of the invention;

FIG. 15 illustrates a block diagram of a postal device and system according to an embodiment of the invention; and

FIG. 16 illustrates a flow diagram of a postal device and system according to an embodiment of the invention.

While the invention is described with reference to the above drawings, the drawings are intended to be illustrative, and the invention contemplates other embodiments within the spirit of the invention.

### DETAILED DESCRIPTION

The present invention is described hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Some embodiments of the invention combine a mailbox and a recognition component such as a scanner and/or a camera in a single device. In some embodiments, a mailbox is alternatively or further combined with a dimension and weight determining component comprised of sensors, lasers, cameras, or scales, or a combination thereof, that determine dimensions and weight of correspondence, including letters, parcels, or packages, or any object. In some embodiments, after inserting correspondence such as mail or a package, into the terminal of the Postal System of Recognition of Physical Correspondence according to an embodiment of the invention, it is automatically recognized, including for example scanned, photographed, recorded, imaged, read, converted into image, sound and text, weighed by electronic scales located inside the terminal and dimensions are determined and measured via sensors and/or imaging components. A postal system may include a system for carrying, transporting or delivering services of packages, parcels, documents, mail, and the like. Other configurations are also contemplated.

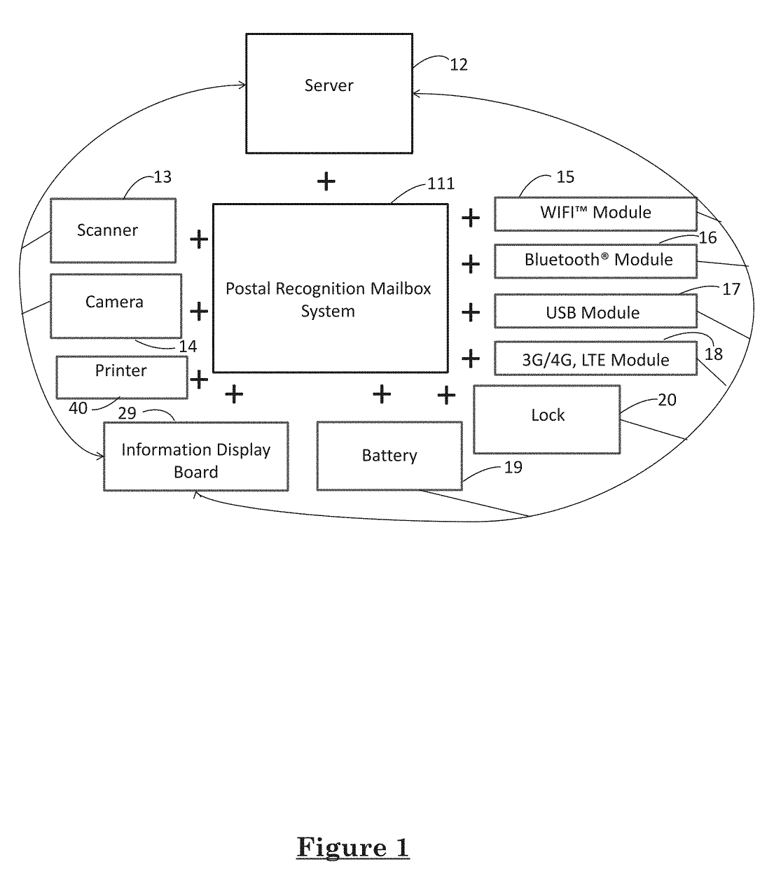

FIG. 1 illustrates a block diagram of a postal device and system according to an embodiment of the invention. FIG. 1 illustrates Postal Recognition Mailbox System 111, computer server 12, scanner 13, camera 14, WIFI™ module 15, Bluetooth® module 16, USB module 17, mobile communication module 18, power supply unit 19, digital interactive lock 20, information display board 29 and printer 40.

As shown in FIG. 1, Postal Recognition Mailbox System 111 includes single-side or double-side scanner 13, photo/video camera 14, WIFI™ module 15, Bluetooth® module 16, USB module 17, 3G/4G and LTE cellular communication module 18, rechargeable battery with power supply unit 19, mechanical, digital interactive lock 20, information display board 29, printer 40, and computer server 12 with integrated software. Postal Recognition Mailbox System 111 may also include casing or housing which may be constructed with steel, plastic, wood or any other material suitable for container, casing or mailbox manufacturing. The housing or casing may be a cube or a square or a rectangle with rounded corners, or a sphere or any regular or irregular shape. The casing may encase or be coupled with other components of Recognition Mailbox System 111. In some embodiments, at least some of the above-mentioned components may be implemented or configured or positioned outside of Recognition Mailbox System 111 and some components may be omitted or replaced with other components. The interactive lock 20 may be protected by a passkey entered via input on the mailbox, on the lock itself, or transmitted via an electronic device, or may be unlocked via a physical unlocking mechanism or a key. The camera 14 may also be positioned on the outside of the mailbox for previewing correspondence, or detecting presence of correspondence, or detecting presence of a courier or a user, or the like.

The various components of Postal Recognition Mailbox System 111 described herein may be equipped with additional modules implemented with hardware, software and memory, such as Secure Digital (SD) cards, memory cards or flash memory, required for their unimpaired and uninterrupted operation both as independent units and within the overall system in general. The software component may be used to operate each component independently or include instructions for interaction with other components. The instructions may also include instructions to unlock the Postal Recognition Mailbox System and instructions to provide information about contents, including weight and dimensions, log or history of mailbox use, including sending, weighting, etc., or unlocking, count of items inside the mailbox, and the like. The memory may be configured to store various states of each component, or operational history, for example, whether the component is idle or in use, and include configurations and tags for each component.

At least some, or all of the components of the Postal Recognition Mailbox System 111 are powered by rechargeable battery with power supply unit 19, which ensures the high-quality and uninterrupted performance of all the components both as independent units and within the system in general. In some embodiments, the components may each be independently powered. In some embodiments, the components may be powered via direct electricity with the battery as a backup source. The battery is recharged from the electric supply network through the power supply unit and ensures the uninterrupted operation of the whole system in case of the power supply failure.

At least some, or all the components of Postal Recognition Mailbox System 111 are also connected to computer server 12 with integrated software that control and coordinate the operation of all the components included into Postal Recognition Mailbox System 111 both separately and in general, as well as their interaction with each other and with other external devices.

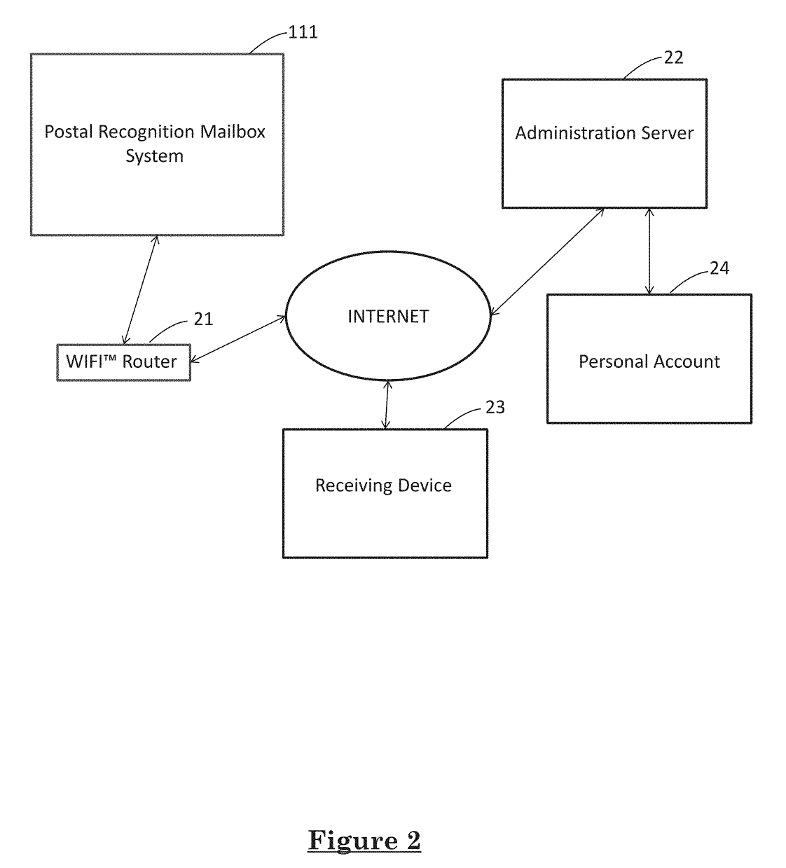

FIG. 2 illustrates a block diagram of a distributed computerized postal system that can implement one or more aspects of a Postal System, Apparatus or Method of Recognition of Physical Correspondence according to an embodiment of the invention. FIG. 2 illustrates Postal Recognition Mailbox System 111, router 21, administration server 22, mailbox owner's receiving device 23, and mailbox owner's personal account 24.

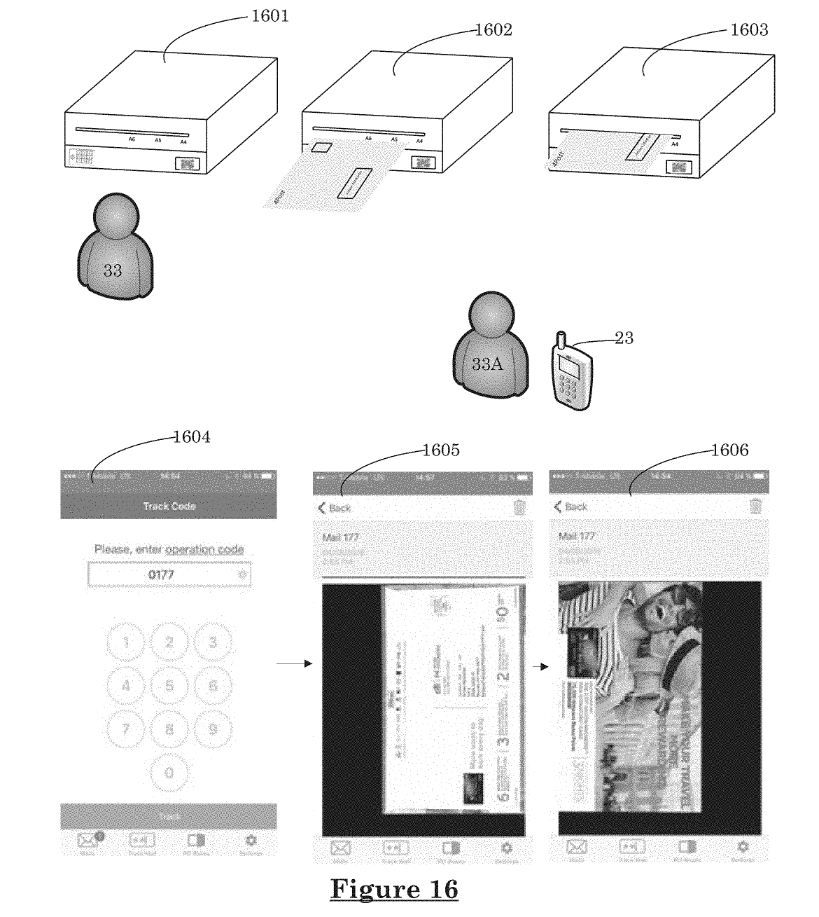

As shown in FIG. 2, Postal Recognition Mailbox System 111 establishes communication with administration server 22 and mailbox owner's receiving device 23 via Internet, using WIFI™ router 21. The administration server 22 may control operation of the entire system and coordinate information processing and transmission for mailbox owner's personal account 24, for example a personal account on the postal operator website, including the correspondence-related information received. Personal account 24 may be similar to an electronic email account or in combination with an electronic email account. A user may register via an application provided by a Recognition Mailbox System service provider. The application may register the user for a personal account by the user entering personal and financial information. FIG. 16 below includes screenshots from one example of a personal account. The personal account may include information about the user and the mailbox and all related information. In essence, the personal account may be a virtual representation of the mailbox. For example, the personal account may include all information related to receiving and sending correspondence, your profile, all the correspondence you sent, all the correspondence you received, visual representations of the information, images of the correspondence, time stamps related to sending and receiving the correspondence, the other party's information, such as sender or recipient information, and the like. For example, such a Recognition Mailbox System may be used by landlords and tenants to send and receive rent payments. Some landlords impose a late fee if rent payment is received late so a time stamp of receipt is crucial in such situations. A tenant may use the Recognition Mailbox System to send the payment in a letter envelope, which can be tracked while it's being sent to the landlord and the landlord will know whether the payment was received without even having to go to the mailbox.

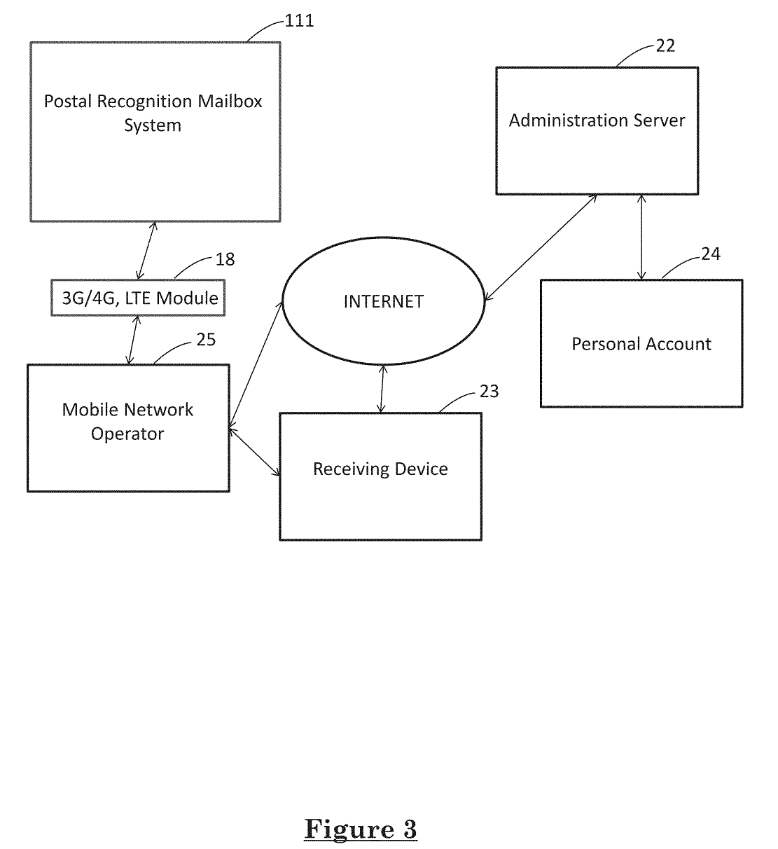

FIG. 3 illustrates a block diagram of a distributed computerized postal system that can implement one or more aspects of a Postal System, Apparatus or Method of Recognition of Physical Correspondence according to an embodiment of the invention. FIG. 3 illustrates Postal Recognition Mailbox System 111, mobile communication module 18, administration server 22, mailbox owner's receiving device 23, mailbox owner's personal account 24, and Mobile Network Operator 25.

As shown in FIG. 3, the Postal Recognition Mailbox System 111 may establish communication with the administration server 22 and mailbox owner's receiving device 23 directly or via an Internet connection enabled by Mobile Network Operator 25 using for example 3G/4G and LTE cellular communication module 18 and coordinate and process information between receiving device 23 and mailbox owner's personal account 24, information including correspondence-related information and instructions, for example time stamps, time stamps associated with receiving the correspondence, time stamps associated with sending the correspondence, images of the correspondence, scanned images, photographs and videos of the correspondence, information about the sender or recipient, such as name, address, personal account information, route and timing of delivery of the correspondence, cost of sending the correspondence, options presented to the user regarding delivery of the correspondence, including pricing and vendors for all the options. Personal account information may be stored in the cloud and provided as a software as a service by the service provider, and/or saved on the administration server 22 and provided by the server.

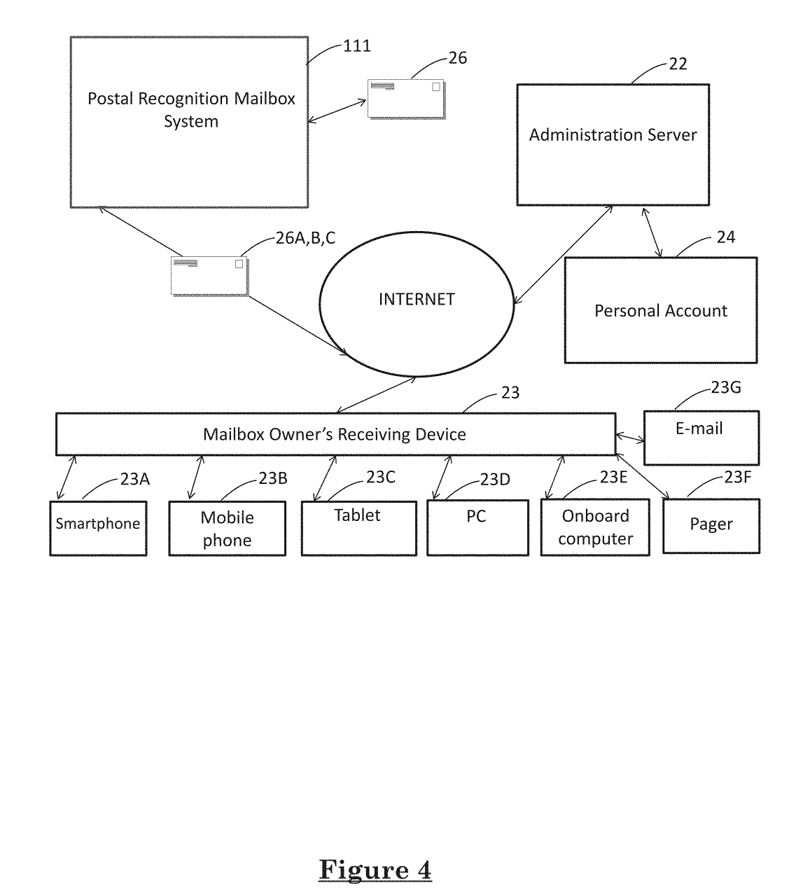

FIG. 4 illustrates a block diagram of a distributed computerized postal system that can implement one or more aspects of a Postal System, Apparatus or Method of Recognition of Physical Correspondence according to an embodiment of the invention. FIG. 4 illustrates Postal Recognition Mailbox System 111, administration server 22, mailbox owner's receiving device 23, mailbox owner's personal account 24, physical correspondence 26, smartphone 23A, mobile phone 23B, tablet 23C, personal computer (PC) 23D, vehicle onboard computer 23E, electronic pager 23F, electronic mail (e-mail) 23G, image converted correspondence 26A, audio converted correspondence 26B, and text converted correspondence 26C.

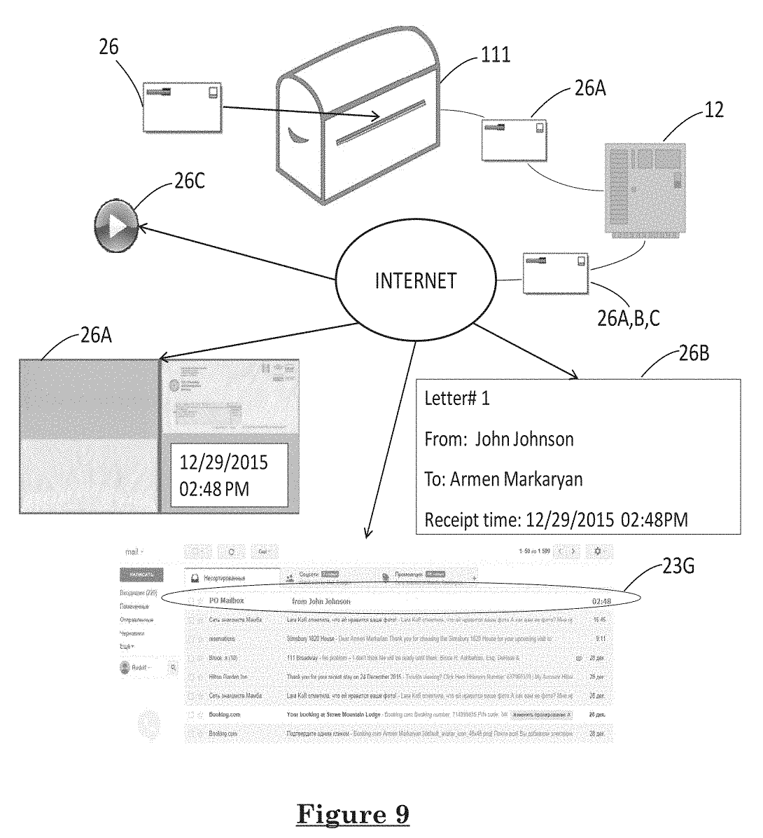

As shown in FIG. 4, the paper or other physical correspondence 26 is processed in the system illustrated in FIG. 1. For example, physical correspondence 26 passes scanner 13 when entering the mailbox connected to the computer server 12 with integrated software via Bluetooth® module 16, the WIFI™ module 15 and/or the USB module 17, and the correspondence 26 gets formatted and converted into electronic correspondence 26 A, B, C, including image, audio, and text, respectively. According to an embodiment of the invention, when correspondence 26 is dropped into Postal Recognition Mailbox System 111, it is scanned by scanner 13 as an image in PDF or JPEG format 26A (as illustrated for example in FIG. 9), or in any other acceptable format and uploaded to computer server 12 with integrated software. Alternatively, the picture of correspondence is taken by photo/video camera 14 and uploaded to computer server 12 with integrated software. According to an embodiment of the invention, server 12 with integrated software processes the image and connects the Internet via WIFI™ router 21 and sends the image and related information to the mailbox owner's receiving device 23. Server 12 (as illustrated for example in FIG. 3) with integrated software, processes the image and sends information relating to the received correspondence, including sending an image 26A, a voice message in MP3 format 26B and a text message 26C to the mailbox owner's receiving device 23 using the 3G/4G LTE module 18 directly through the Mobile Network Operator 25 or via an Internet connection. Correspondence-related information may be sent to the mailbox owner's receiving device 23 directly through the Mobile Network Operator 25 bypassing the Internet connection, if necessary. Correspondence-related information may be sent to the mailbox owner's receiving device 23 via other communication formats, for example, if the user is near the mailbox and downloads such information to the receiving device 23.

In the course of sending such information, server 12 with integrated software interacts with administration server 22, which controls the correct operation of the whole system in general and backs up the information on the correspondence received in the mailbox owner's personal account 24 at the postal operator website.

Depending on the mailbox owner's receiving device 23 configuration and type, the provided information on the correspondence received may be displayed as image in PDF or JPEG format or in any other format acceptable, as a text message in HTML format or any other format acceptable and/or as a voice message in MP3 format or any other format acceptable.

As shown in FIG. 4, when paper or other physical correspondence 26 is dropped into Postal Recognition Mailbox System 111, it is scanned by scanner 13 as an image in PDF or JPEG format 26A or in any other acceptable data format, the usage of which is supported by the server 12 with integrated software, and uploaded into computer server 12 with integrated software, which in turn converts the image into voice message in MP3 format 26B and a text message 26C or into any other acceptable data format consumable by a user, or for example, a format supported by the mailbox owner's receiving device 23, and sends the data to the mailbox owner's receiving device. The image can get converted into text using optical character recognition (OCR). The mailbox owner's receiving device 23 includes smartphone 23A, mobile phone 23B, tablet 23C, PC 23D, vehicle onboard computer 23E, electronic pager 23F, e-mail 23G or any other device and resource configured and capable of receiving the data in such formats. The data related to image converted correspondence 26A, audio converted correspondence 26B, and text converted correspondence 26C may be sent to all the mailbox owner's receiving devices, to a single device or to a group of devices at the option of the mailbox owner. The mailbox owner's receiving device 23 is configured to process and utilize the particular data format. For example, an electronic pager receives data only in text format 26B, a regular mobile phone receives data as a voice mail or only voice messages 26C, while other devices supporting all the data formats available, such as smartphones, may receive all the three data types of messages 26A, B, C, A voice and text message, may for example, include the sender's information such as name and address, as well as other aspects related to the correspondence, such as dimensions, weight, time of receipt, and the like. For example, when a user receives correspondence, a text or voice message may state that “you received a message from ‘user's name’ at ‘date and time stamp of receipt.”’ When you user sends correspondence, the message may state that “the correspondence that you mailed on ‘date and time stamp on sending’ was received by ‘receiving user’ at ‘date and time stamp of receipt.’”

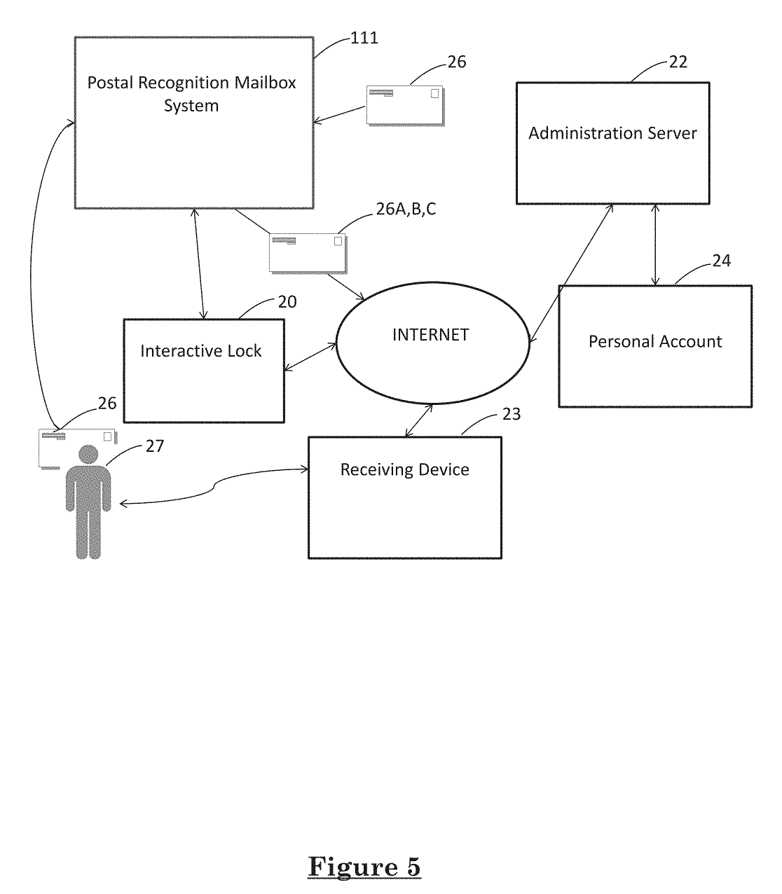

FIG. 5 illustrates a block diagram of a distributed computerized postal system that can implement one or more aspects of a Postal System, Apparatus or Method of Recognition of Physical Correspondence according to an embodiment of the invention. FIG. 5 illustrates Postal Recognition Mailbox System 111, digital interactive lock 20, administration server 22, mailbox owner's receiving device 23, mailbox owner's personal account 24, physical correspondence 26, courier 27, image converted correspondence 26A, audio converted correspondence 26B and text converted correspondence 26C.

As shown in FIG. 5, after correspondence 26 is dropped into Postal Recognition Mailbox System 111 and processed by scanner 13, among being processed via other components, and the respective data 26A, 26B, 26C are provided to the mailbox owner via the mailbox owner's receiving device 23, the mailbox owner may contact the courier 27 for the purpose of correspondence 26 delivery from Postal Recognition Mailbox System 111 to the mailbox owner. With the mechanical digital interactive lock 20 installed on or coupled with the mailbox system, the mailbox owner using the mailbox owner's receiving device 23 may remotely open the mechanical digital interactive lock 20 of Postal Recognition Mailbox System 111 via the Internet connection in order to enable the courier 27 to pick up the correspondence 26 and deliver it to the mailbox owner, after which the mailbox owner may remotely close the mechanical digital interactive lock 20 of Postal Recognition Mailbox System 111 via the Internet connection. Alternatively, the mailbox owner may provide the courier with a onetime passcode, an encrypted electronic key that may be sent to courier's device to be used for opening the mailbox, or a physical unlocking mechanism such as a key, or a combination thereof. Moreover, with mechanical digital interactive lock 20 installed on or coupled with the mailbox system, the mailbox owner may have complete information regarding access to his/her mailbox, as every opening and/or closing is registered by the mailbox or the mailbox owner's receiving device 23.

Postal Recognition Mailbox System can be opened via a key or electronic lock that accepts a combination password. Every opening of the mailbox, the person trying to open is verified and authorized, for example, via passcode, or biometric identification, finger print, retinal scan or face recognition. Also, the mailbox owner is notified that a user is opening the mailbox and other information is provided such as date and time of opening, duration of opening, and authorization information, and images, video, or sound recording of a user opening the mailbox, and scan, photograph or video of the correspondence placed or removed. If it is determined that the access is unauthorized, a user or the system may immediately send instructions to close or lock the mailbox and ring a security alarm in the mailbox, or notify the authorities to indicate that a mailbox break-in is occurring. Such mailboxes may be equipped with cameras and sound recorders to verify authorized users or identify vandalism.

When using an electronic lock, the device is registered as opened or closed via electronic means or a sensor in the lock. If using a key to open or close, there is a sensor on the electronic lock that notifies the system that the box was opened and closed. The Postal Recognition Mailbox System also stores information related to duration of opened and closed states of the mailbox. This information may be stored as a log and provided to the user in the users personal account.

The Postal Recognition Mailbox System may also be used as a safe between users, where important documents can be stored. The Postal Recognition Mailbox System is configured with a secure enclosure, being secured, for example, by a digital interactive or mechanical lock. The mailbox may also be used as a secure way of serving important documents on the user, and when accessed, it can be considered as the user is served with the documents officially. This can be a sure way to have been legally served with important documents or subpoenas. When receiving such legal documents, the mailbox and the system can specially notify the user of a presence of such documents.

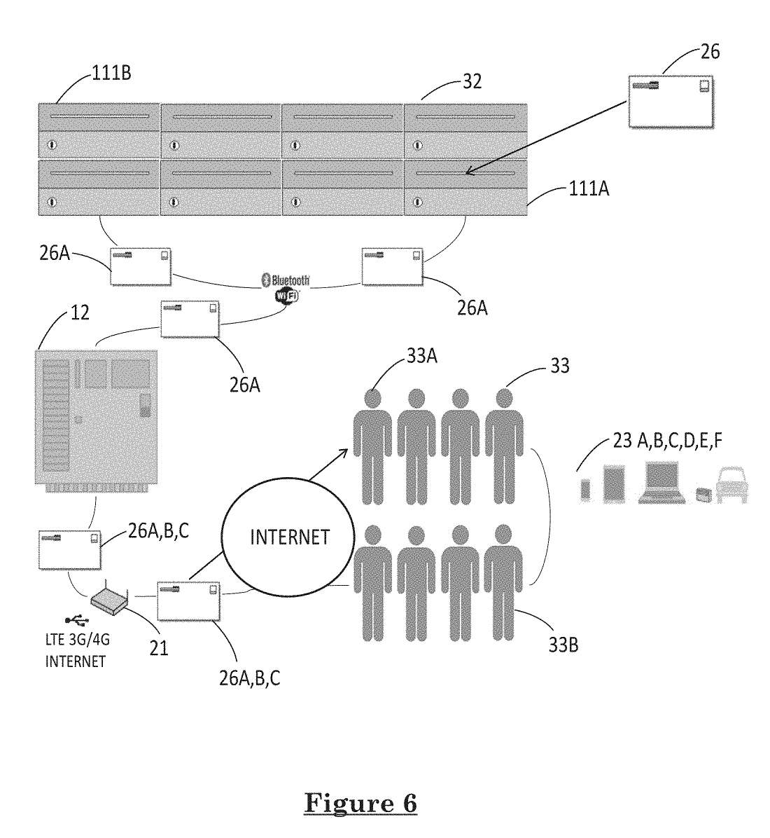

FIG. 6 illustrates a diagram of a postal device and system according to one or more aspects of a Postal System, Apparatus or Method of Recognition of Physical Correspondence according to an embodiment of the invention. FIG. 6 illustrates Postal Recognition Mailbox Systems 111A and 111B, computer server 12, router 21, smartphone 23A, mobile phone 23B, tablet 23C, personal computer 23D, vehicle onboard computer 23E, electronic pager 23F, electronic mail 23G, physical correspondence 26, image converted correspondence 26A, audio converted correspondence 26B, text converted correspondence 26C, postal terminal 32, users 33, receiving device users 33A, receiving device users 33B.

FIG. 6 illustrates postal terminal 32 including eight mailboxes, such as Postal Recognition Mailbox System mailboxes 111A and 111B. Such postal terminal configuration is most convenient for post office box mailbox service, residential apartment blocks and offices. Although eight mailboxes are illustrated, the total number of mailboxes and systems may be different and determined by the customer depending on their personal needs. Each mailbox system may include the components illustrated in FIG. 1, except for example, server 12, which may be installed outside the mailbox.

For example, correspondence 26 is dropped into Postal Recognition Mailbox System 111A, where it passes scanner 13 and gets into the mailbox's interior space. Via connection established by the Bluetooth® module 16 and/or WIFI™ module 15 and/or USB module 17, scanner 13 uploads the image 26A to the server 12 with integrated software. Server 12 process the data and determines that the correspondence was placed exactly into Postal Recognition Mailbox System 111A, after which the data on the correspondence received 26A, B, C are sent to the receiving device users 33A assigned by the owner of the Postal Recognition Mailbox System 111A, directly or via an Internet connection.

When the correspondence 26 is dropped into the Postal Recognition Mailbox System 111B, then scanner 13 of the Postal Recognition Mailbox System 111B, via connection established by Bluetooth® module 16 and/or WIFI™ module 15 and/or USB module 17, uploads image 26A to server 12 with integrated software. Server 12 process the data and determines that the correspondence was placed exactly into Postal Recognition Mailbox System 111B, after which data on the correspondence received 26A, B, C is sent to the receiving device users 33B assigned by the owner of the Postal Recognition Mailbox System 111B, directly of via the Internet connection. Therefore, several Postal Recognition Mailbox Systems 111 installed at the postal terminal may be operated by a single server 12 with integrated software.

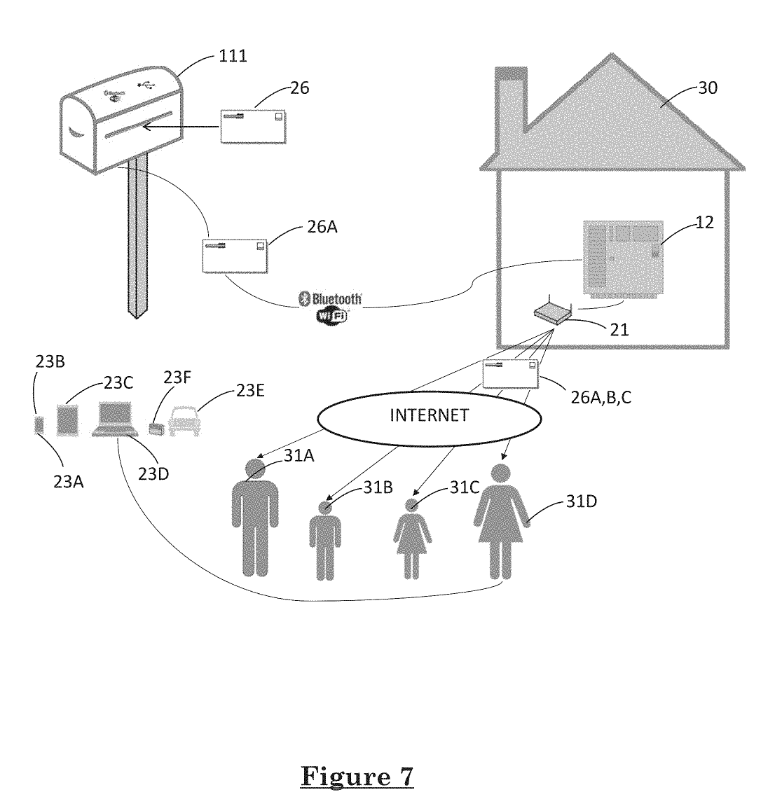

FIG. 7 illustrates a diagram of a postal device and system according to one or more aspects of a Postal System, Apparatus or Method of Recognition of Physical Correspondence according to an embodiment of the invention. FIG. 7 illustrates Postal Recognition Mailbox System 111, computer server 12, router 21, physical correspondence 26, smartphone 23A, mobile phone 23B, tablet 23C, personal computer 23D, vehicle onboard computer 23E, electronic pager 23F, image converted correspondence 26A, audio converted correspondence 26B, text converted correspondence 26C, residential apartment block 30, father 31A, child 31B, child 31C, and mother 31D.

FIG. 7 shows configuration of Postal Recognition Mailbox System 111 installation for the separate residential apartment block 30. The specific feature of such a mailbox with paper and other physical correspondence recognition features is that server 12 is located inside the residential apartment block 30, while the Postal Recognition Mailbox System 111 itself is located outdoors. After the correspondence 26 is placed into the Postal Recognition Mailbox System 111 and scanned by scanner 13 uploading the respective image 26A into server 12 with integrated software via connection established by the Bluetooth® module 16 and/or WIFI™ module 15 and/or USB module 17, server 12 determines the specific correspondence addressee among the family members, and sends the data 26A, B, C on the correspondence received, to the specific correspondence 26 addressee receiving device directly or via Internet connection. FIG. 7 shows that the correspondence may be addressed to father 31A, mother 31D or children 31B and 31C. Mailbox 11 may also include an additional compartment for other types of correspondence, non-conventional dimensions or weight. It should be noted that after any correspondence is inserted into the housing, the correspondence gets lowered into the enclosure for safe and secure keeping. The next user that opens the housing will have only an empty container into which to place the correspondence.

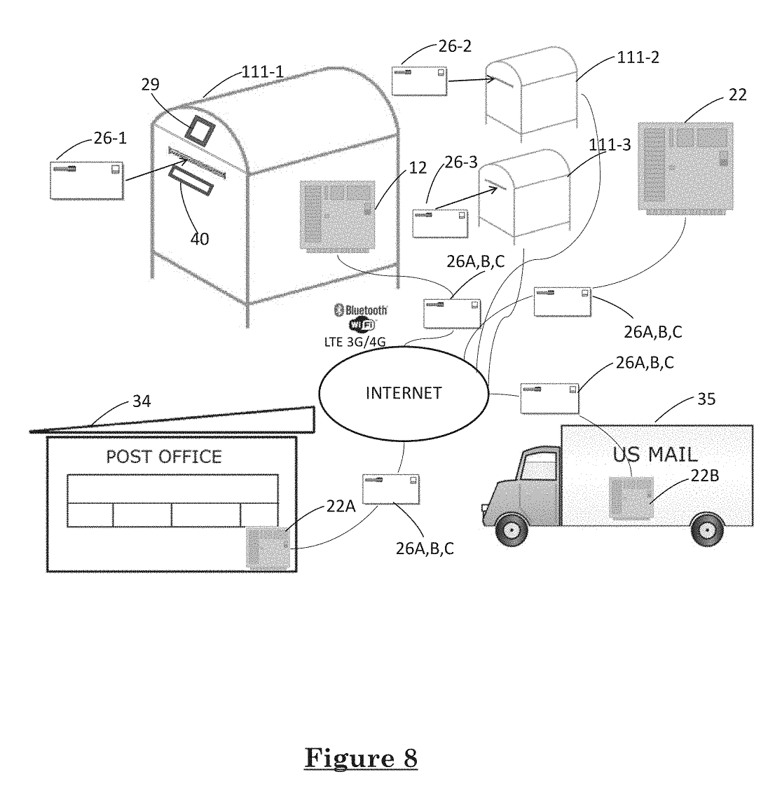

FIG. 8 illustrates a diagram of a postal device and system according to one or more aspects of a Postal System, Apparatus or Method of Recognition of Physical Correspondence according to an embodiment of the invention. FIG. 8 illustrates Postal Recognition Mailbox Systems 111-1, 111-2, 111-3, computer server 12, administration server 22, physical correspondence 26, correspondence 26-1, 26-2, 26-3, image converted correspondence 26A, audio converted correspondence 26B, text converted correspondence 26C, postal office 34, postal vehicle 35, and printer 40.

FIG. 8 illustrates Postal Recognition Mailbox System with remote street location for postal services according an embodiment of the invention. Here, Postal Recognition Mailbox System 111 is in large dimensions and complies with the standard size of the postal service street mailboxes. Server 12 with integrated software is located inside the Postal Recognition Mailbox System 111. The Postal Recognition Mailbox System 111-1 maintains the continuous connection with the administration server 22, server 22A installed at the postal office 34 and server 22B installed at the postal vehicle 35 via server 12 using the Bluetooth® module 16 and/or WIFI™ module 15 and/or USB module 17. The Postal Recognition Mailbox Systems 111-2 and 111-3 are located on other streets, operate according to a similar procedure.

As described herein, Postal Recognition Mailbox System 111 optimizes correspondence collection and sorting workflow. Server 22 receives the data on correspondence 26-1 incoming into Postal Recognition Mailbox System 111-1, correspondence 26-2 incoming into Postal Recognition Mailbox System 111-2 and correspondence 26-3 incoming into Postal Recognition Mailbox System 111-3 by maintaining the continuous connection with the server 22A installed at the postal office and the server 22B installed at the postal vehicle, and coordinates the correspondence collection time, taking into account the time of correspondence entry into the mailbox. The postal service usually utilizes the standard schedules of the correspondence delivery and corresponding collection from the publicly available mailboxes. For example, the standard schedule provides for collection of correspondence from a publicly available mailbox twice a week, so the correspondence is for example collected each Wednesday and each Saturday. If no new letters have been dropped and processed by the mailbox, since the last collection day, the next collection may be performed on Saturday rather than on Wednesday. The particular mailbox may be excluded from the postal vehicle route saving time and cost. As another example, since the last collection day, five new letters were dropped into mailbox on Tuesday, but the electronic system processing the available information on the delivery addressees calculates the correspondence delivery time and determines that as long the maximum scheduled delivery time is seven days, then even if all the correspondence stored at the given mailbox is collected on Saturday rather than on Wednesday, the postal service will still comply with the standard schedule. In this case, such mailbox may also be excluded from the postal vehicle route ensuring additional time and cost saving. As another example, if an unacceptable correspondence has been placed into the mailbox or a mailbox needs maintenance or fixing, the mailbox can be flagged for attention or maintenance, before the collection date.

Such mailboxes may include public mailboxes that may be remote, and the courier and postal company can save time, resources, and expenses, by skipping this mailbox. Such mailboxes can optimize sending important, rushed and expensive correspondence, for example, correspondence that requires airmail. If a postal vendor is aware that there are a thousand packages coming from New York to Atlanta, the postal vendor now knows to book a big enough carrier, and thus can optimize their own resources.

Also, with preliminary information on all the mailboxes addressees available, the server 22 may regulate the advance dispatch of correspondence to the regional offices before correspondence arrival and sorting at the post office 34, which provides another opportunity for time and cost saving. Thus, the post office may plan routing, and delivery earlier in the process, which is especially beneficial during high volume periods, such as holidays.

FIG. 9 illustrates a diagram of a postal device and system according to one or more aspects of a Postal System, Apparatus or Method of Recognition of Physical Correspondence according to an embodiment of the invention. FIG. 9 illustrates Postal Recognition Mailbox System 111, computer server 12, physical correspondence 26, electronic mail 23G, image converted correspondence 26A, audio converted correspondence 26B and text converted correspondence 26C.

FIG. 9 shows various types of messages sent to the receiving device of the owner of the mailbox with paper and other physical correspondence recognition features according to the present invention. For example, 26A is a double-sided image of correspondence 26 produced by scanner 13, which is sent to the receiving device of the mailbox owner. It also includes additional data on the time of correspondence 26 entry into the Postal Recognition Mailbox System 111, as well as, for example, information related to physical attributes of the correspondence, or an image of the sender taken by a camera outside or near the mailbox, or the like.

The mailbox may retrieve information about the correspondence relevant to sending the package, such as weight, dimensions, to and from information, and based on that information can determine pricing information for all different service providers and provide all the options by all the postal service providers for sending the correspondence.

The text message 26B sent to the mailbox owner's receiving device is textual information related to the correspondence, including for example, correspondence sender, correspondence addressee, correspondence acceptance time, information regarding weight and dimensions, dispatch information, tracking information, and the like.

The voice message 26C sent to the mailbox owner's receiving device is the voice information related to the correspondence, such as correspondence sender, correspondence addressee and correspondence entry time, and the like. The message may be a text-to-speech version of the text message or it may include additional information, such as a voice recording of the sender. For example, a user can leave a voice message during dropping off the mail at a mailbox about what the user is dropping off or a general voice note, for example “Hi Bob, I'm sending you the blueprints we were talking about yesterday.” This voice message may be provided to the recipient via text or via voice message. Such a mailbox is equipped with an external or built in microphone and/or camera as one of the components. Such a mailbox may also be equipped with a speaker for interacting with the user. For example, the Postal Recognition Mailbox System may be equipped with microphone, speaker and voice recognition software and may be operated by a user via speech instructions.

The Postal Recognition Mailbox System may also be equipped with a fan, temperature control components, or sensors for temperature, or a thermostat, and if the mailbox determines that the temperature is above a threshold temperature, the mailbox may turn on the fan to regulate the temperature, or control the temperature control components to bring the temperature to a suitable value. The threshold temperature may be set by a particular user or when sending a temperature sensitive correspondence.

The e-mail message 23G sent to the mailbox owner's e-mail address is the electronic message containing the image, textual or sound/voice information related to the correspondence sender, correspondence addressee and correspondence entry time.

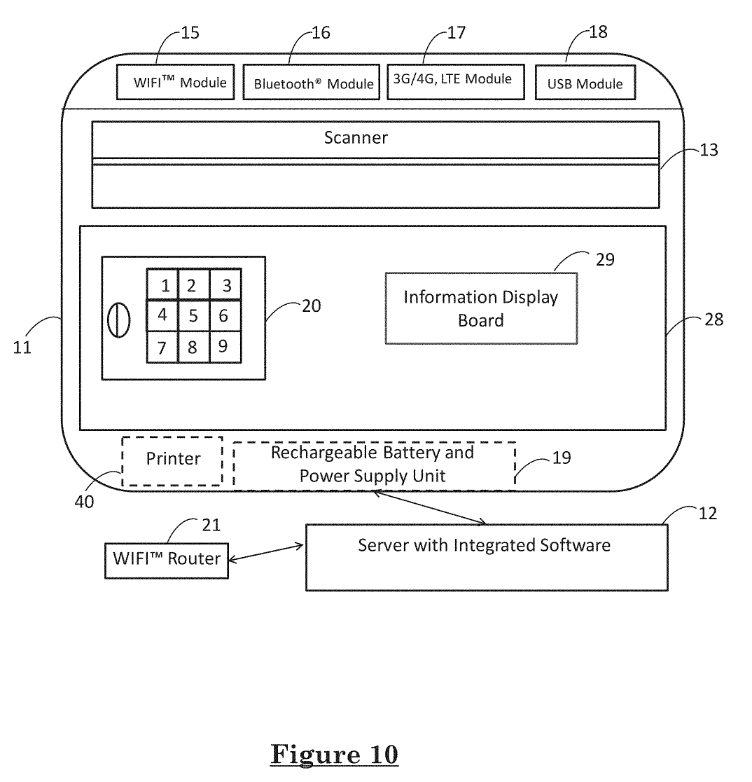

FIGS. 10, 11 and 12 illustrate block diagrams of various configurations of a postal device and system that can implement one or more aspects of a Postal System, Apparatus or Method of Recognition of Physical Correspondence according to an embodiment of the invention. According to an embodiment of the invention, the Postal Recognition Mailbox System 111 uses single-side or double-sided scanner 13 as the main technical device. According to an embodiment of the present invention, Postal Recognition Mailbox System 111 also uses photo/video camera 14 in addition to the single-side or double-side scanner 13.

FIG. 10 illustrates a block diagram of a postal device and system that can implement one or more aspects of a Postal System, Apparatus or Method of Recognition of Physical Correspondence according to an embodiment of the invention. FIG. 10 illustrates casing 11, computer server 12, scanner 13, WIFI™ module 15, Bluetooth® module 16, USB module 17, mobile communication module 18, power supply unit 19, digital interactive lock 20, router 21, door 28, information display board 29 and printer 40.

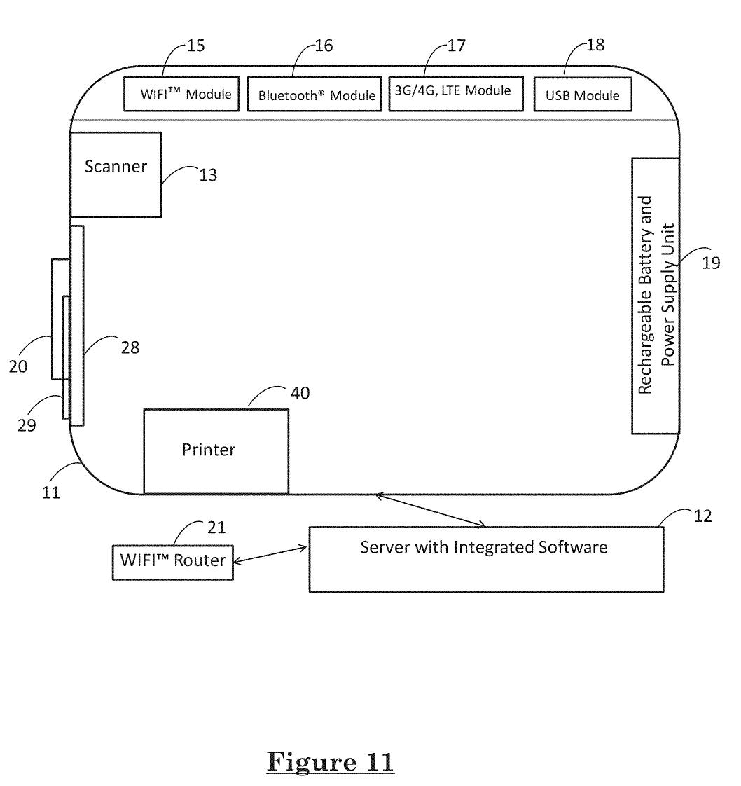

FIG. 11 illustrates a block diagram of a postal device and system that can implement one or more aspects of a Postal System, Apparatus or Method of Recognition of Physical Correspondence according to an embodiment of the invention. FIG. 11 illustrates casing 11, computer server 12, scanner 13, WIFI™ module 15, Bluetooth® module 16, USB module 17, mobile communication module 18, power supply unit 19, digital interactive lock 20, router 21, door 28, information display board 29 and printer 40.

The FIGS. 10 and 11 illustrate a schematic front-view and cross-section view of a mailbox according to an embodiment of the present invention. As shown in FIG. 10, Postal Recognition Mailbox System 111 has casing 11 made of any suitable solid material intended for such purpose, such as iron sheet, or plastic. The upper part of casing 11 accommodates WIFI™ module 15, Bluetooth® module 16, USB module 17 and 3G/4G and LTE cellular communication module 18. Scanner 13, through which the correspondence 26 may enter Postal Recognition Mailbox System 111 is located immediately below, in the front part of the casing 11. Under the scanner 13, there is a door 28, which can be opened by mechanical digital interactive lock 20. The back part of the casing 11 accommodates the rechargeable battery with power supply unit 19, which ensures uninterrupted power supply to all the energy-consuming devices of the Postal Recognition Mailbox System 111. Depending on the configuration and purpose of the Postal Recognition Mailbox System 111, server 12 with integrated software, rechargeable battery with power supply unit 19 and WIFI™ router 21 may be located both inside and outside the casing 111.

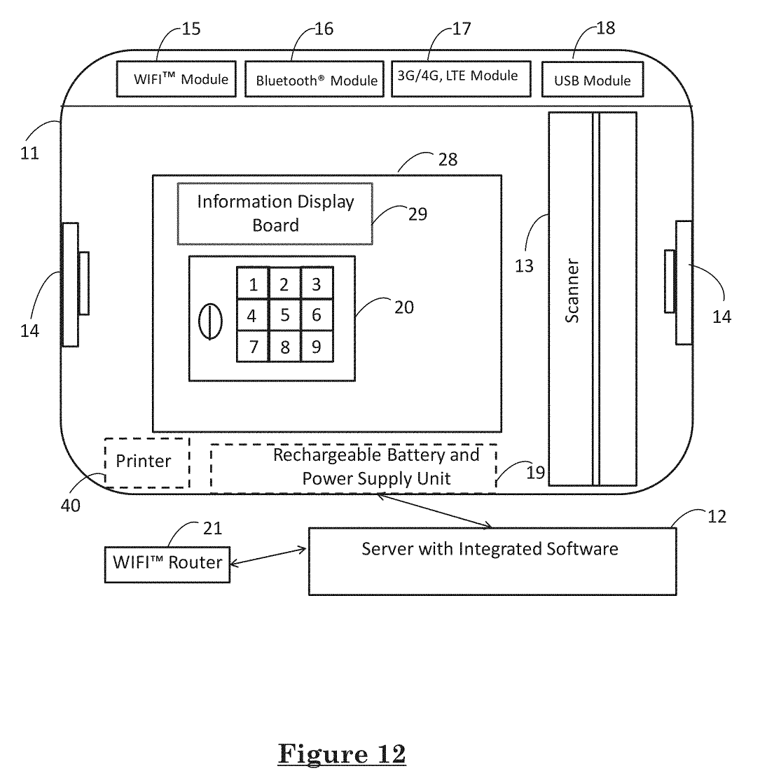

FIG. 12 illustrates a block diagram of a postal device and system that can implement one or more aspects of a Postal System, Apparatus or Method of Recognition of Physical Correspondence according to an embodiment of the invention. FIG. 12 illustrates casing 11, computer server 12, scanner 13, camera 14, WIFI™ module 15, Bluetooth® module 16, USB module 17, mobile communication module 18, power supply unit 19, digital interactive lock 20, router 21, door 28, information display board 29 and printer 40.

FIG. 12 shows a schematic view of a mailbox configured according to an embodiment of the invention. In addition to scanner 13, which is installed in vertical position in this example, the sidewalls of casing 11 accommodate two photo/video cameras 14, the technical capabilities of which allow them to take pictures of the correspondence 26 at the moment of its entry into Postal Recognition Mailbox System 111. In FIG. 12, scanner 13 may be combined with or substituted with, photo/video cameras 14 or any other device able to independently identify or upload images of correspondence 26A to server 12 via WIFI™ module 15, Bluetooth® module 16, USB module 17 and/or 3G/4G and/or LTE cellular communication module 18. Server 12 with integrated software ensures the operation of the whole Postal Recognition Mailbox System 111 system, including the operation of its separate components, their interaction and common operation.

Scanner 13 may be configured as a double-sided mobile scanner, for example, such as DSmobile®920DW manufactured by Brother® in the Postal Recognition Mailbox System 111.

At or before entry of letter into the street configuration of the mailbox through the Postal System of Recognition of Physical Correspondence according to an embodiment of the invention, the digital information board displays the digital code, QR-code or bar code that can be read by the sender's smartphone. The digital information board is a digital display or a touch screen display that can simply display a barcode, QR code, or an alphanumeric or numeric reference code, where a user may scan or enter the code into a smart device and be directed to detailed information or user interface regarding the correspondence or the mailbox. The display or information board may also or instead provide the same information on the board. Alternatively, the information display board may provide some information via codes, such as QR codes and barcodes and some information directly on the display board. For example, a user may be able to pull up the appropriate information and interface via smartphone and interact and enter information via the user's smartphone, or the display may display the information and allow input for information directly via the display. The mailbox may additionally be equipped with a keypad for entering payment information, or a credit card reader. Alternatively, a user may enter paying account information via the interface via the smartphone or the display board. Alternatively, the user may pay via a smartphone wallet. Thus, the user can pay for postage at the mailbox, eliminating the need for buying stamps or postage. While the mailbox according to the invention is configured to operate entirely without stamps, it is also configured to accept stamps and modify postage as needed. For example, if a user submits a heavy envelope with one stamp, the mailbox weighs the envelope, reads that there is one stamp where there should be two, applies a second stamp onto the correspondence. The mailbox according to the invention may use image recognition to determine a value of a stamp. Some stamps that do not have a value printed on the stamp, for example a forever stamp, the mailbox may refer to a database of postage to determine the value of the recognized postage.

After reading one of such codes, the picture of the letter is sent and uploaded to an application according to Postal System of Recognition of Physical Correspondence according to an embodiment of the invention, installed on the sender's smartphone with indication of the exact sending date and time, and tracking number enabling the sender to track the letter delivery up to the moment of receipt by the addressee.

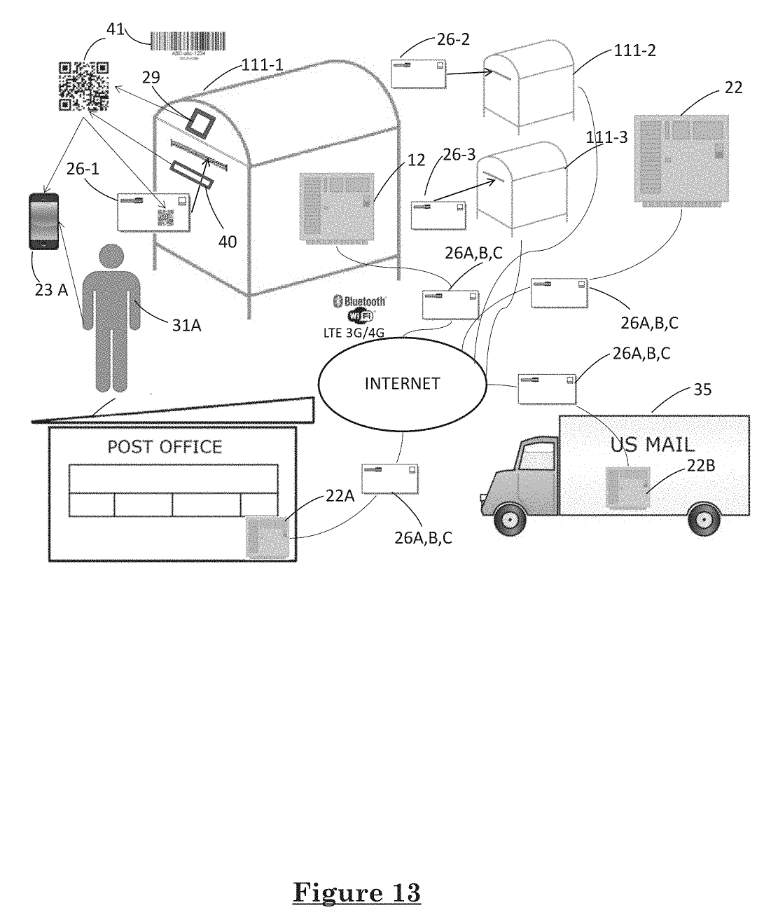

FIG. 13 illustrates a diagram of a postal device and system according to one or more aspects of a Postal System, Apparatus or Method of Recognition of Physical Correspondence according to an embodiment of the invention. FIG. 13 illustrates Postal Recognition Mailbox System 111-1, Postal Recognition Mailbox System 111-2, Postal Recognition Mailbox System 111-3, computer server 12, administration server 22, administration server 22A, administration server 22B, smartphone 23A, correspondence 26-1, correspondence 26-2, correspondence 26-3, image converted correspondence 26A, audio converted correspondence 26B, text converted correspondence 26C, information display board 29, father 31A, postal vehicle 35, printer 40 and QR code 41.

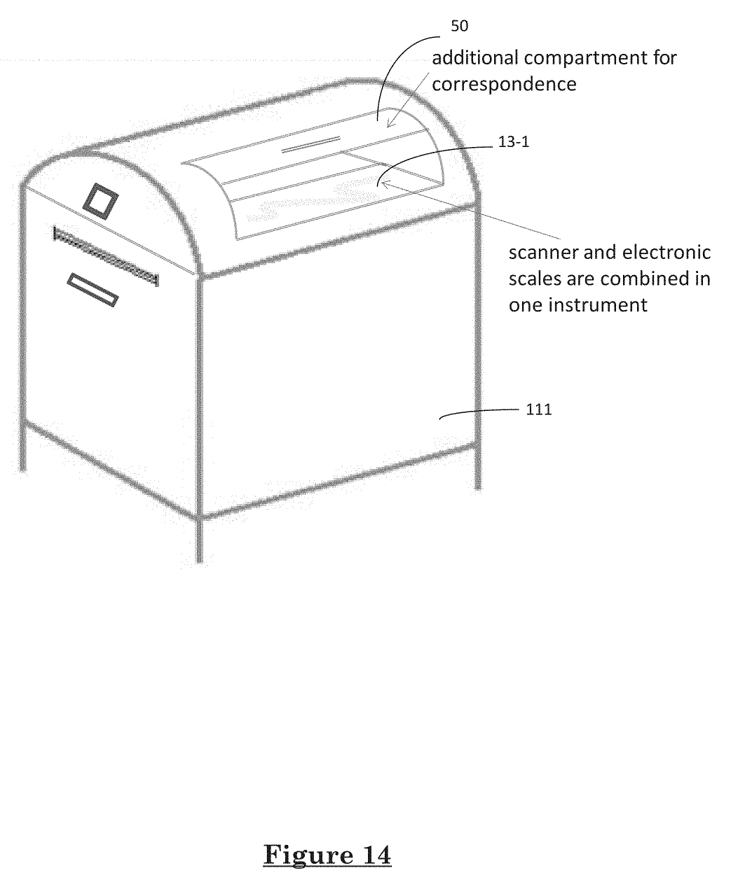

FIG. 14 illustrates a block diagram of a postal device and system according to an embodiment of the invention. FIG. 14 illustrates Postal Recognition Mailbox System 111, additional compartment 50, and scanner 13-1. As illustrated in FIG. 14, The mailbox 11 also has an additional compartment for additional correspondence. For example, additional correspondence may include non-standard shaped envelopes or packages, as well as standard correspondence. Compartment 50 may be located on the side of the terminal of the Postal System of Recognition of Physical Correspondence according to an embodiment of the invention, and may open automatically after a QR code or barcode is printed and scanned by the sender's smartphone. In this case, the application of the Postal System of Recognition of Physical Correspondence according to an embodiment of the invention, in the sender's smartphone pre-requests information from the sender that a letter or oversized mail item is sent. If the sender confirms that an oversized postal item is being sent, an additional compartment is automatically opened where the mail can be added. In this compartment, the scanner and electronic scales may be combined in one instrument. After the sender has placed the postal compartment in the additional compartment, the compartment closes, and scans the mail to determine size, shape, dimensions, weight, and other physical attributes.

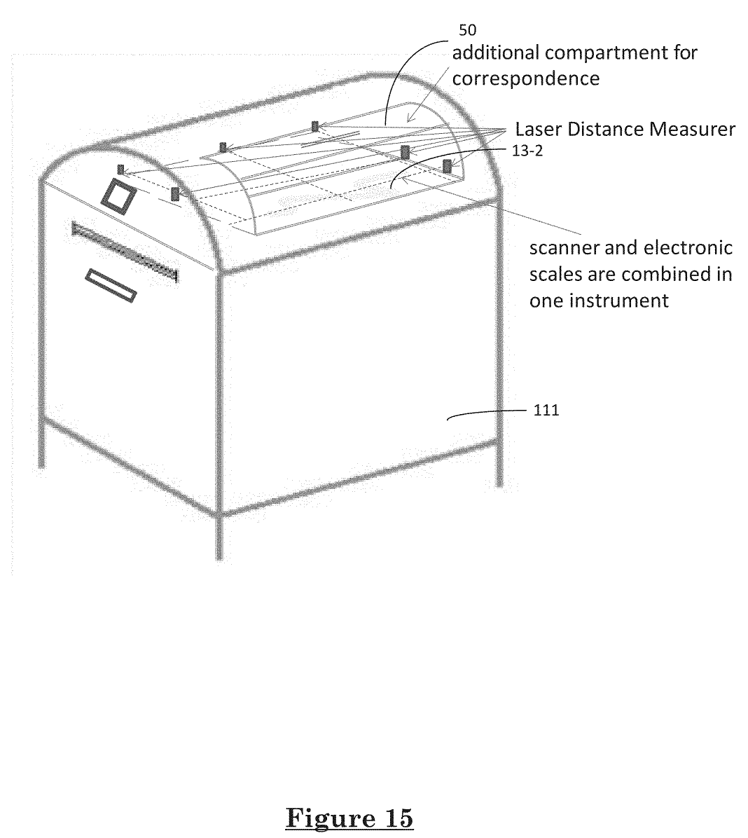

FIG. 15 illustrates a block diagram of a postal device and system according to an embodiment of the invention. FIG. 15 illustrates Postal Recognition Mailbox System 111, additional compartment 50 and scanner 13-2.

As illustrated in FIG. 15, scanner 13-2 includes laser distance measurer which is configured to measure the dimensions of physical correspondence. Inside the mailbox, at various locations throughout, the laser distance measurers are positioned and determine the sizes of oversized packages or unconventionally shaped correspondence, as well as typical correspondence dimensions. The lasers may also be used to sense the interior of the housing. The lasers may also be replaced by sensors for sensing the interior of the housing relative to the content of the housing and the sensors may be located in various locations in the interior of the housing. The sensors may be infrared sensors. Dimensions of correspondence may also be measured alternatively or additionally by a camera or imaging components. The dimensions of the package may also be determined via a video or photo camera. The camera is configured to be aware of general dimensions of the enclosure and can derive the dimensions of the package via calculations based on the distance from the walls of the enclosure to the sides of the correspondence. Alternatively, or additionally, the distance measurer may be configured with a vertical, horizontal, or multidirectional moving arms that move towards the object until reaching the object to determine or verify dimensions.

FIG. 16 illustrates a flow diagram of a postal device and system according to an embodiment of the invention. FIG. 16 illustrates mailbox owner's receiving device 23, sending user 33, receiving user 33A, and steps 1601-1606. In step 1601, user 33 approaches the device according to the invention with correspondence, for example a letter. In step 1602, after inserting the letter into the terminal of the Postal System of Recognition of Physical Correspondence according to an embodiment of the invention, the system feeds in the later and begins processing. In Step 1603, the system may attach a label containing a QR-code or bar code to the envelope. The QR-code or bar code label may be printed in advance by the sending user 33 via printer 40 (not shown) or automatically attached by the terminal of the Postal System of Recognition of Physical Correspondence according to an embodiment of the invention, after the letter insertion. User 33 may pay the delivery price using the smartphone application rather than buying a postage stamp. The system may also process the letter if the user previously purchased a stamp. The application automatically performs calculation and provides the data on delivery taking into account the type of service, delivery distance and time. After the calculation, sending user 33 may choose the most convenient letter sending option and pay the delivery price using the application or the information display board. The calculation includes determining options and presenting the options to the sending user 33 (not shown) regarding delivery of the correspondence, including pricing and vendors for all the options. In step 1604, receiving user 33A receives a notification on his device 23 and enters operation code to view the mail. In step 1605, the system displays the front of the scanned correspondence. In step 1606, the system displays the back of the correspondence.

At or before entry of mail into the street configuration of the mailbox through the module of the Postal System of Recognition of Physical Correspondence according to an embodiment of the invention, the digital information board displays the digital code, QR-code or bar code that can be read by the sender's smartphone. After reading one of the such codes, an image of the letter sent is uploaded to the application of Postal System of Recognition of Physical Correspondence according to an embodiment of the invention, installed on the sender's smartphone with indication of the exact sending date and time, tracking number enabling the sender to track the letter delivery up to the moment of receipt by the addressee.

After inserting the mail into the terminal of the Postal System of Recognition of Physical Correspondence according to an embodiment of the invention, the label containing the letter QR-code or bar code is attached to the envelope. Herewith, such QR-code or bar code label may be printed in advance by the sender or automatically attached by the terminal of the Postal System of Recognition of Physical Correspondence according to an embodiment of the invention, after the letter insertion. For example, the Postal System of Recognition of Physical Correspondence may print and attach the label or print directly onto the envelope or package.

Postal System of Recognition of Physical Correspondence according to an embodiment of the invention, converts the information from an envelope or a mail item into electronic formats, such as a text format, and determines the address of the recipient. In addition, through the smartphone, the sender receives a confirmation of the place of delivery of the letter or mail. The sender can also enter information about the place of delivery and the recipient independently, via the smartphone. All relevant information is attached to the QR code or barcode. To calculate the cost of delivery of the letter, the place of departure determines the place of the actual location of the terminal.

Having full information about the weight of the postal item, the place of departure and the place of delivery, Postal System of Recognition of Physical Correspondence according to an embodiment of the invention, automatically generates an electronic application and sends it to all postal services, such as UPS, USPS, FedEx, DHL and so on, in order to receive a quote or an offer with terms and tariffs for the delivery of this mail. Having received from all postal services proposals for the delivery of this mail, the terminal of the Postal System of Recognition of Physical Correspondence according to an embodiment of the invention, provides or sends all offers to the sender, to his smartphone, sorted for example based on cost of shipping the mail. Alternatively, the terminal may provide the information on the display of the terminal. The terminal also gives recommendations to the sender on the choice of the best option, taking into account the price/time ratio of delivery, as well as sender entered preferences. After receiving full information about various options for delivering mail by all postal services, the sender selects a service in his smartphone or on the display, with the name of the postal service, the cost and time of delivery, and pays for the service through a smartphone or display or directly at the terminal using a bank card or electronic wallet.

All information about the place of departure, the place of delivery, the postal service, the cost and time of delivery, the name of the recipient, the name and address of the sender, as well as other necessary information is attached to the QR code or the barcode pasted on the mail. When the courier of the Postal System of Recognition of Physical Correspondence according to an embodiment of the invention, picks up the mail from the terminal of the Postal System of Recognition of Physical Correspondence according to an embodiment of the invention, the courier receives this information using a reader from a QR code or bar code and delivers the letter or mail to the mail service selected by the sender. The courier may read information from the correspondence, or download all the information directly from the terminal. Throughout the delivery, Postal System of Recognition of Physical Correspondence according to an embodiment of the invention, sends notifications to the smartphone or other electronic devices belonging to the sender and/or recipient or any other interested, authorized or registered party, about the location of the letter or postal item, until it is delivered to the recipient.

The advantages of the Postal System of Recognition of Physical Correspondence according to an embodiment of the invention described herein include providing significant time and cost saving not only for the customer, but also for delivery company, as long as the postal courier will not have to come and collect every Priority Mail envelope as part of the Click-N-Ship® or Priority Mail Express® service, but will be able to pick up all the correspondence stored at the mailbox according to an embodiment of the invention, mailbox once per day. Then the postal service may sort the letters based on images or pictures and QR and/or bar codes attached or downloaded from the terminal. The sender will not have to arrive at the post office or wait for the courier visit. Such mailboxes may be installed in office buildings, apartment complexes, or anywhere on the street for regular consumer use.

Postal System of Recognition of Physical Correspondence according to an embodiment of the invention, may also provide significant saving of costs, if installed at the street mailboxes in the remote locations. The postal operators will have access to accurate information on the presence of letters in the mailboxes in order to decide whether it is feasible to send a courier for collection.

Postal System of Recognition of Physical Correspondence according to an embodiment of the invention, helps optimize the logistics costs incurred by the postal companies. By implementing and configuring the Postal System of Recognition of Physical Correspondence according to an embodiment of the invention, at the street mailboxes, the postal operator will possess accurate information on the number of letters in the box with indication of specific addresses, which provides an opportunity to determine the types and means of correspondence delivery to various regions in advance.

Using the Postal System of Recognition of Physical Correspondence according to an embodiment of the invention, it is also possible to establish the multi-brand postal operator. For example, the sender inserts the letter into the terminal of the Postal System of Recognition of Physical Correspondence according to an embodiment of the invention, scans the digital code with smartphone and receives the complete information on the letter sent specifying the sender's and the recipient's address and the time of letter acceptance by the Postal System of Recognition of Physical Correspondence according to an embodiment of the invention. Then, using the smartphone application, the sender may choose the type of service and the time of delivery. After the respective choice is made, the application displays the offers by various postal operators and delivery companies specifying the prices and delivery terms. For example, the sender wants to send the registered letter in an envelope of specific size and weight to Los Angeles from New York. The application displays the specific rates and delivery terms offered by several operators such as USPS®, FedEX®, UPS, DHL®, etc. Based on sender personal preferences, the sender may choose the most convenient offer and pay the delivery price online using any of the available payment methods. Alternatively, this functionality may be available directly on the mailbox and provided to the user via a touch display, or a regular display with a keypad, or a combination thereof.

The sender receives notifications of the letter's current location at all stages of delivery starting from acceptance by the terminal of the mailbox according to an embodiment of the invention, and up to receipt by the addressee that are forwarded to the sender's smartphone with the copy sent to the e-mail address and the application of the Postal System of Recognition of Physical Correspondence according to an embodiment of the invention. Notifications may be sent once the correspondence is scanned at various points on the route, for example receiving hubs, transportation vehicles, receiving cities, and any other points on the route where the package is scanned when receiving or dispatching the package or correspondence.

An aspect of some embodiments of the invention provides a system for recognition of paper or any physical correspondence and immediate notification of a mailbox owner of correspondence receipt consisting of a mailbox, scanner, photo and video camera, Bluetooth® modules, WIFI™ and USB, 3G/4G and LTE cellular modules, WIFI™ router, mechanical door lock, interactive digital lock, rechargeable battery, energizing module, and a software server ensuring an uninterruptable and optimum co-functioning of any and all devices and modules of the System for recognition of paper or any physical correspondence and immediate notification of a mailbox owner of correspondence receipt and the System in general.

An aspect of some embodiments of the invention provides a mailbox and a scanner converting images into any digital format. The mailbox and scanner are combined. The mailbox may be configured as a Post box (mailbox collecting outgoing mail), Letter box (mailbox collecting incoming mail), and as a Post office box.

An aspect of some embodiments of the invention provides interacting with devices receiving any data such as pagers, cell phones, smartphones, tablet PCs, laptops, desktop PCs, car's or bike's onboard computers, printers, TV sets, home phones, as well as with administrator's servers, cloud storages, administrator's internet page, electronic postal services, electronic mail transfer agents, software and mobile apps, using which a mailbox owner is quickly and qualitatively notified of arrival of paper and/or physical correspondence to his/her mailbox.

An aspect of some embodiments of the invention provides interacting with a mailbox owner, postal service, postal service officers and any individuals or legal entities contributing to qualitative and quick delivery of data of incoming correspondence and incoming correspondence as such to the mailbox owner.

An aspect of some embodiments of the invention provides any paper and/or physical correspondence arriving to the mailbox passes through a single or double-sided scanner mounted on a mailbox wall. Depending on location and size of a mailbox, the scanner may be mounted on any part or wall of the mailbox. It may be mounted on either back or front wall of the mailbox, if it is, for example, a Post office box, or on the front or upper wall of the mailbox, if it is, for example, a Letter box in an apartment block, or it may be mounted on the front or side wall of the mailbox, if, for example, it is installed in a home. The scanner may be accompanied by a photo/video camera or be replaced by it. At the moment or during placement of any correspondence to the mailbox, the scanner and/or photo/video camera takes a picture and/or video and images all sides of the correspondence. The images of the incoming correspondence may be formatted in any digital format (PDF, JPEG, TEXT, MP3 or any other available formats) allowing to reproduce, save or transfer such an image or video via Internet or SMS or via any other means enabling to transfer the image, will be sent to any mailbox owner's devices and/or any other cellular or desk devices being able to receive such images, audio information, text files or any other files.

An aspect of some embodiments of the invention provides transferring or receiving the images by utilizing the software facilitating qualitative and quick transfer and processing of the image as well as any audio or text information. The device receives the image and any audio or text information, may use, alongside with the software, the applications in Android, iOS, Windows mobile, Windows and Linux, and/or in any other operating system allowing to make such operations and installed in a device.

An aspect of some embodiments of the invention provides a mailbox owner means of registering his/her virtual mailbox, which will receive any information of content of his/her tangible mailbox in digital formats.

An aspect of some embodiments of the invention provides that information concerning the content of the mailbox may arrive to e-mail of the mailbox owner in digital formats, thus combining the virtual and physical worlds.

An aspect of some embodiments of the invention provides that alongside with visual, text and audio information in digital formats, a mailbox owner will receive the information pertaining to time the correspondence was delivered to the mailbox, placed in the mailbox, processed by the mailbox, retrieved from the mailbox, etc., and, log or historical information on opening or closing the mailbox, associated with correspondence placed or taken when being closed or opened.

An aspect of some embodiments of the invention provides that the system may be primarily used in mailboxes installed in residential buildings, apartment blocks, offices and any other premises and places using mailboxes for the purpose of receiving paper and/or physical correspondence or packages.

An aspect of some embodiments of the invention provides an apparatus for physical correspondence recognition and processing in a postal system, the apparatus comprising a housing or a casing or encasing comprising an opening configured for receiving physical correspondence, the physical correspondence including at least one readable element, and a secure enclosure for storing the physical correspondence, a visual processing and digitizing component coupled to the housing or the opening, configured for processing the physical correspondence and the at least one readable element, a dimension and weighing component coupled to the housing, configured for determining dimensions and weight of the physical correspondence and a communication component coupled to the housing, configured for transmitting and receiving, or a transceiver component, recognition and processing information related to the physical correspondence. Recognition may include identifying any aspect of physical correspondence, metadata, sender address, dimensions, weight, physical attributes, and the like.

The apparatus further comprises a digital information board coupled to a surface of the housing configured for displaying information related to the housing or the physical correspondence.

The visual processing and digitizing component of the apparatus further includes at least one of a scanner, a photo camera and a video camera.

The apparatus further comprises a marking component configured for adding an indication onto the physical correspondence. The indication may include indication regarding postage, actual postage, or addressee and recipient information. The indication may be added by first marking a label and then applying a label onto the physical correspondence. The marking component may include a printer, a stamp, a raised seal impression embosser or tool, or a label maker or a combination of both.

The at least one readable element of the apparatus includes at least one of a QR code, a barcode, a name, an address, and an identifier.

The communication component of the apparatus is further configured for receiving instructions from, or being controlled by, an electronic device. The controlling device includes a smart device such as a smartphone, tablet, or even remote personal computer via the internet and the administration server, or a controlling device used by couriers or postal service providers.)

The apparatus further comprises a data storage component configured for storing information related to the physical correspondence.

The apparatus further comprises a mechanical or digital interactive lock, coupled to the housing, configured for locking and unlocking based at least in part on remote instructions received by the communication component, wherein the remote instructions include verification-related or authorization-related information. Verification-related or authorization-related information may include information that a user has been authorized or verified to open the mailbox, that the user may enter a particular passcode to open the mailbox, that the user may open the mailbox via biometric identifiers, such as fingerprint or retinal scan, or face recognition.

The visual processing and digitizing component of the apparatus is further configured for detecting, identifying or imaging the physical correspondence simultaneously or contemporaneously from all sides of the physical correspondence,

The apparatus further comprises determining at least one of a sender and a recipient based on the at least one readable element, wherein the visual processing and digitizing component comprises at least one of a single or a double-sided scanner or a camera, configured for imaging or scanning simultaneously all sides of the detectable object or physical correspondence.

The dimension and weighing component further comprises an electronic or mechanical component configured for determining weight or dimensions of the physical correspondence, wherein dimensions and weight are determined by sensors or lasers. As another example, the weight may be determined by a scale inside the casing or housing of the mailbox. The scale may be combined with other components or may be a standalone component. The scale may keep track of the weight of all the items already in the mailbox and determine a new item weight by subtracting the previous total weight from the new total weight. The scale may weight each new item separately. The scale may be configured as a hanging scale or a plate scale. The scale may be positioned on the bottom of the housing or encasing and keeps track of all the correspondence that is being dropped into the mailbox such that any additional correspondence weight can be derived from the previous total weight and resulting total weight. The scale may be positioned above all the correspondence such that each new correspondence is weighted separately.

The apparatus further comprises determining a postage for the physical correspondence, verifying if included postage matches the postage determined for the physical correspondence, and marking the physical correspondence with the postage determined for the physical correspondence when the included postage does not match the postage determined for the physical correspondence. In the case where the postage already exists on the correspondence but falls short, the apparatus may mark the correspondence with the difference in value, or remove the incompatible postage and add a new postage. The marking of an additional stamp is performed by determining nearby available space near the existing postage for placing the additional postage and placing the additional postage in the appropriate space within a particular distance from the additional postage, as determined by image recognition.

An aspect of some embodiments of the invention provides a method for physical correspondence recognition and processing in a postal system, the method comprising receiving a physical correspondence including at least one readable element, by a housing comprising an opening and a secure enclosure for storing the physical correspondence, processing the physical correspondence and the at least one readable element, by a visual processing and digitizing component coupled to the housing, and transmitting and receiving recognition and processing information related to the physical correspondence, by a communication component, or a transceiver component, coupled to the housing.

The method further comprises displaying information related to the housing or the physical correspondence, by a digital information board coupled to a surface of the housing. The digital information board may include a display screen, a touch screen, or an electronic display, or a combination thereof.

The physical correspondence and the at least one readable element is processed by the visual processing and digitizing component comprises at least one of a scanning by a scanner, including at least one of a single side scanning or a multiple side scanning, capturing at least one photo by a photo camera and recording at least one video by a video camera.

The method further comprises marking or adding an indication onto the physical correspondence or a new object, by a marking component. The marking component may include a printer or a label maker or a combination of both. The marking component may print onto the correspondence, or make a label for applying onto the correspondence. The marking or label may include information relevant to sending the correspondence or other instructions or notes related to the correspondence.

The at least one readable element includes at least one of a QR code, a barcode, a name, an address, and an identifier. The readable element may be handwritten or printed, including address labels, names, instructions or the like.

The method further comprises receiving by the communication component instructions from, or being controlled by, an electronic device.

The method further comprises storing information related to the physical correspondence, by a data storage component.

The method further comprises receiving remote instructions by the communication component, wherein the remote instructions include verification-related information authorization-related information and operating, including locking and unlocking, a mechanical or digital interactive lock, coupled to the housing, based at least in part on the remote instructions.

An aspect of some embodiments of the invention provides an apparatus for a mail object recognition and processing in a postal system, the apparatus comprising a mailbox housing comprising an opening configured for receiving a detectable object including at least one of a physical correspondence, paper, mail, parcel, package, envelope, or book, wherein the detectable object includes at least one readable element, a secure enclosure for storing the detectable object, coupled to the mailbox housing or within the mailbox housing, a mechanical or digital interactive lock, coupled to the mailbox housing, configured for locking and unlocking the secure enclosure based at least in part on remote instructions, a visual processing and digitizing component coupled to the mailbox housing or the opening, configured for scanning or imaging the detectable object and the at least one readable element, a postage processing component configured for determining dimensions of the detectable object, determining weight of the detectable object, and determining a postage for the detectable object, and a wireless communication component coupled to the mailbox housing, configured for communicating with electronic devices, mobile applications, and remote servers, transmitting and receiving recognition and processing information related to the detectable object, and transmitting a notification to at least one of a mailbox housing operator, a postal system operator, the sender and the recipient, regarding receipt of the detectable object or physical correspondence, a timestamp of the receipt and access information related to unlocking the mailbox housing for accessing the secure enclosure.

While the invention is described with reference to the above drawings, the drawings are intended to be illustrative, and the invention contemplates other embodiments within the spirit of the invention.

What is claimed is:

1. An apparatus for physical correspondence recognition and processing in a postal system, the apparatus comprising:
a housing comprising an opening configured for receiving physical correspondence, the physical correspondence including at least one readable element including textual information, and a secure enclosure for storing the physical correspondence;
a visual processing and digitizing component coupled to the housing or the opening, configured for processing the physical correspondence and the at least one readable element including textual information;
a dimension and weighing component coupled to the housing, configured for determining dimensions and weight of the physical correspondence; and
a communication component coupled to the housing, configured for transmitting and receiving recognition and processing information related to the physical correspondence and the readable element.

2. The apparatus of claim 1, further comprising a digital information board coupled to a surface of the housing configured for displaying information related to the housing or the physical correspondence.

3. The apparatus of claim 1, wherein the visual processing and digitizing component includes at least one of a scanner, a photo camera and a video camera.

4. The apparatus of claim 1, further comprising a marking component configured for adding an indication onto the physical correspondence.

5. The apparatus of claim 1, wherein the at least one readable element further includes at least one of a QR code, a barcode, numeric information, a name, an address, and an identifier.

6. The apparatus of claim 1, wherein the communication component is further configured for receiving instructions from, or being controlled by, an electronic device.

7. The apparatus of claim 1, further comprising a data storage component configured for storing information related to the physical correspondence and the readable element.

8. The apparatus of claim 1, further comprising a mechanical or digital interactive lock, coupled to the housing, configured for locking and unlocking based at least in part on remote instructions received by the communication component, wherein the remote instructions include verification-related information.

9. The apparatus of claim 1, wherein the visual processing and digitizing component is further configured for detecting, identifying or imaging the physical correspondence simultaneously or contemporaneously from all sides of the physical correspondence.

10. The apparatus of claim 9, further comprising determining at least one of a sender and a recipient based on the at least one readable element, wherein the visual processing and digitizing component comprises at least one of a single or a double-sided scanner or a camera, configured for imaging or scanning simultaneously all sides of a detectable object or physical correspondence.

11. The apparatus of claim 1, wherein the dimension and weighing component further comprises an electronic or mechanical component configured for determining weight or dimensions of the physical correspondence, wherein dimensions and weight are determined by sensors or lasers.

12. The apparatus of claim 10, further comprising determining a postage for the physical correspondence, verifying if included postage matches the postage determined for the physical correspondence, and marking the physical correspondence with the postage determined for the physical correspondence when the included postage does not match the postage determined for the physical correspondence.

13. A method for physical correspondence recognition and processing in a postal system, the method comprising:
receiving a physical correspondence including at least one readable element including textual information, by a housing comprising an opening and a secure enclosure for storing the physical correspondence;
processing the physical correspondence and the at least one readable element including textual information, by a visual processing and digitizing component coupled to the housing;
determining dimensions and weight of the physical correspondence by a dimension and weighing component coupled to the housing; and
transmitting and receiving recognition and processing information related to the physical correspondence and the readable element, by a communication component coupled to the housing.

14. The method of claim 13, further comprising displaying information related to the housing or the physical correspondence, by a digital information board coupled to a surface of the housing.

15. The method of claim 13, wherein processing the physical correspondence and the at least one readable element by the visual processing and digitizing component comprises at least one of a scanning by a scanner, including at least one of a single side scanning or a multiple side scanning, capturing at least one photo by a photo camera and recording at least one video by a video camera.

16. The method of claim 13, further comprising marking or adding an indication onto the physical correspondence or a new object, by a marking component.

17. The method of claim 13, wherein the at least one readable element includes at least one of a QR code, a barcode, numeric information, a name, an address, and an identifier.

18. The method of claim 13, further comprising the communication component receiving instructions from, or being controlled by, an electronic device.

19. The method of claim 13, further comprising storing information related to the physical correspondence and the readable element, by a data storage component.

20. The method of claim 13, further comprising:
receiving remote instructions by the communication component, wherein the remote instructions include verification-related information; and
operating, including locking and unlocking, a mechanical or digital interactive lock, coupled to the housing, based at least in part on the remote instructions.
